(19) United States
(12) Patent Application Publication
(10) Pub. No.: US 2005/0033628 A1
(43) Pub. Date: Feb. 10, 2005

(54) Contractor certification system

(76) Inventors: David J. Alverson, Morristown, NJ (US); Fred N. Bonar, Santa Ana, CA (US); Kenneth N. Ryan, Newport Beach, CA (US); Roger B. Woodhull, Ocean City, NJ (US)

Correspondence Address: ERNEST D BUFF & ASSOCIATES, LLC, 245 SOUTH ST, MORRISTOWN, NJ, 07960, US

(21) Appl. No.: 10/634,504

(22) Filed: Aug. 5, 2003

(51) Int. Cl. G06F 17/60

(52) U.S. Cl. 705/10

(57) ABSTRACT

A contractor certification system employs a survey with targeted questions and interviews, and job site visits, to objectively analyze business and financial practices of a contractor and assess risks involving the contractor's business. A report provided by the contractor certification system to the surety institutions and to the contractor details the business and financial practices, together with the risks, and ranks the contractor's operation in comparison with industry recognized standards. A database maintained by the contractor certification system contains a compilation of business and financial practices and risk factors derived from previously evaluated contractors, together with their performance histories germane to meeting time objectives and project cost goals. A logo generated by the system graphically depicts the contractor's rank. The logo can be used by the contractor in correspondence with prospective customers.

### BACKGROUND OF THE INVENTION

1. Field of the Invention

The present invention relates to systems for providing business information concerning performance of building contractors; and more specifically, to a contractor certification system for providing a performance assessment, technical evaluation and certification, to assist a surety underwriting a building project.

2. Description of the Prior Art

Many approaches have been disclosed for evaluating home builders, workers and contractors. These evaluation approaches do not rate contractors to provide sureties with underwriting information comprised of capability assessments and performance factors.

U.S. Pat. No. 5,909,669 to Havens discloses a system and method for generating a knowledge worker productivity assessment. The system includes a database containing survey data generated using a knowledge worker productivity assessment framework. A benchmark database contains benchmark values. A retriever is coupled to the databases to retrieve selected survey data and benchmark values. A calculator is coupled to the retriever and generates a comparison value using the selected survey data. A relator compares the comparison value to a selected benchmark value to generate a knowledge worker productivity assessment. This system assesses worker productivity from collected survey data and compares the collected data with benchmark values based on set criteria. However, the system does not probe into the operation and business practices of the contractor to determine surety and lender risks. In addition, the '669 patent disclosure does not suggest providing a meaningful certification.

U.S. Pat. No. 6,038,547 to Casto discloses a construction tracking and payment method and system. A computer-based tracking system and method coordinate work done on a project and payments made. After an architect has partitioned a project, jobs are specified in terms of the region or sub-region to which each entry corresponds. The (sub)contractors submit monthly “Application” and “Certificate for Payment” requests which are organized by the system to enable all the work in a particular region to be consolidated and listed on a reviewer's card for ease of verification. Updates to the requests are made and authorized forms are generated to enable payment of the requests, thereby saving time and effort otherwise required to perform manual correlation of subcontractor requests for a given area in a project. Requests also need not be monthly and may be made at any period, potentially varying. Other possible periods are quarterly, twice a month, or once every two months. This system collects data from contractors verified by reviewer's certification to process payment requests. However, the system does not probe into the operation and business practices of the contractor. In addition, no disclosure is contained in the patent concerning a system that determines surety and lender risks, and provides a meaningful certification.

U.S. Pat. No. 6,308,574 to Thomas et al. discloses a System for providing business information. An apparatus, method and data structure communicate business information, including outsourcing information. Contractors provide information regarding their products and services into the system. Outsourcing companies search a database containing contractor information to determine which contractor meets particular search criteria. Selected contractors receive project information and, optionally, a bid template. Bid information is supplied to the database operator. The operator prepares a table of bid information that is sent to the outsourcing companies for review. Evaluation information relating to contractors and outsourcing companies is obtained from both outsourcing companies and contractors, and stored on a database. The evaluated information is provided to outsourcing companies and contractors as part of the bid and project information. This business information system provides business information of contractors in a database to outsourcing companies matching specified criteria. It also provides contractors with bid information for the outsourcing companies. The patent discloses a system for providing to outsourcing companies business information, including a list of contractors matching specified criteria. No disclosure is contained by the patent concerning a contractor certification system. Moreover, the system disclosed by the patent does not probe into the operation and business practices of the contractor to determine surety and lender risks.

U.S. Pat. No. 6,345,258 to Pickens discloses a process and a system for listing information relating to a construction project over a computer network. The system estimates the progress of a construction project over a computer network. The first step in the process starts when an architect or contractor enters information relating to construction project into an online database. This online database is stored on a server creating a series of quantities for each of the construction projects and a system host presents a series of quantities for each of the construction projects. Next, users such as contractors, subcontractors or construction managers can purchase and download these quantities and a construction report. These quantities are presented in a unique electronic spreadsheet template. Once the users have this template with the quantities included, they can bid on each construction project either online or through any other communication means. This network based system host coordinates the construction project, providing a template suitable for bidding; and provides relevant information to engineers, architects, builders, contractors, sub-contractors and suppliers. No disclosure is contained by the patent concerning a contractor certification system. Moreover, the system disclosed by the patent does not probe into the operation and business practices of the contractor to determine surety and lender risks.

U.S. Pat. No. 6,393,410 to Thompson discloses an information system for new homebuilders. The information system is used by builders that reuse house plans or product information for new homes that they build. Three distinct steps in the process are used as the basis for the information model: product development, procurement and order fulfillment; and accordingly, the software is divided into three modules. The option module is used at on-site sales offices, facilitating the automated selection of defined builder options, creating a customized completed house design package with pricing. The procurement/contracting module is used to maintain quotes and contract information on subcontractors. The production/scheduling module is used to manage the activities of all subcontractors, to ensure timely and efficient meeting of construction deadlines and the approval of all work as completed by subcontractors for payment. The information system uses semantic database tools and stores information of objects, relationships, and role players at levels of detail required for building a new home economically and at predetermined project levels. This information system is used by home builders for pricing a new home based on procurement data. It monitors home build progress against set time levels and negotiated costs. The fulfillment module allows the sales person to negotiate with a customer using the price provided by the procurement module, and create a contract. The fulfillment module also tracks the progress of the project. No disclosure is contained by the patent concerning a contractor certification system. The system disclosed by the patent does not probe into the operation and business practices of the contractor to determine surety and lender risks.

U.S. patent application Ser. No. 2002/0087332 to Como discloses a system and method for a contractor locator. The invention comprises a system and method for enabling a user on a network to locate contractors in at least one designated location. This networked Internet connected system locates a contractor or a sub-contractor based on a set of database criteria pertaining to specific locality. It also provides other functions including an estimator for costing jobs, a gap analysis to compare estimated costs with actual costs and automated auction function that auctions off unused overstocked items. The patent application to Como does not disclose a contractor certification system. In addition, the system disclosed by the Como application does not probe into the operation and business practices of the contractor to determine surety and lender risks.

U.S. patent application Ser. No. 2002/0087381 to Freeman et al. discloses a project management system for complex construction projects wherein subcontractors are monitored in real time. A contractor contracts with a manufacturer to construct a device and the manufacturer contracts with a number of subcontractors that supply goods and services necessary for construction of the device. Once construction begins, the computer program begins executing. Whenever a subcontractor realizes a need for a change in specification or anticipates any other reason that might delay completion of construction as scheduled, the subcontractor accesses the contractor's computer via an extranet site on the Internet. Once access is gained, the subcontractor selects the appropriate new status for the subcontractor's task from a computerized menu, and provides other information relevant to the changed situation. The status change is displayed on a display device comprising an electronic dashboard. A manager or engineer in charge of the project notes the status change on the display and reads the information provided by the subcontractor. Other persons may be notified of the status change. With the information provided, the manager or engineer, with whatever input may be provided by the other persons notified of the status change, decides the best course of action to keep the construction on schedule. This system provides for delays by sub-contractors, so that the project may be brought back onto a planned schedule. The system disclosed by the patent application provides for delays by sub-contractors, so that the project may be brought pack onto a planned schedule. Such a system is not a contractor certification system. Moreover, the system disclosed by the patent application does not probe into the operation and business practices of the contractor to determine surety and lender risks.

U.S. patent application Ser. No. 2002/0107723 to Benjamin et al discloses a self-learning method and apparatus for rating service providers and predicting future performance. The method relates to creating a supplier-rating matrix for rating services of a supplier by defining a plurality of job attributes and sub-attributes, each representing a range of job attribute values and defining a ‘job attribute vector’ associated with the supplier. The method further includes defining a plurality of performance metrics and defining a ‘performance vector’ associated with the supplier. The method includes the steps of defining initial values for the job attribute vector and the performance vector and generating a supplier rating matrix for the supplier by mathematically combining the ‘job attribute vector’ and the ‘performance vector’ and uses updated values to predict future performance of a supplier. The supplier rating system disclosed by the patent application does not rate contractors. It relies strictly on data input by keyboard or by direct transmission. No disclosure is contained by the patent application concerning a system that evaluates any of the details of the data provided. Moreover, the system disclosed by the patent application is not a contractor certification system. Further, the system of the patent application does not probe into the operation and business practices of the contractor to determine surety and lender risks.

U.S. patent application Ser. No. 2002/0107790 to Nielson discloses a System and method for extending automatically secured credit to building project owners and to building contractors for purchasing building supplies from building supply wholesalers. This provides building contractors, owners, and material men with a more secure, less risky means of financing materials purchases for building projects. A contractor enters into a contractual agreement with a third-party lender to purchase supplies on credit from a building supply wholesaler. The building supply wholesaler also contracts with the lender to have the lender manage their sales on account to contractors approved by the lender. In exchange for the lender's promises to extend credit upon approval to contractors it approves and to pay approved contractors' accounts with the building supply wholesaler, both the contractor and the wholesaler assign their rights to record and enforce mechanics' liens relating to the building supplies to the lender. The system and method may employ the use of digital signature and notary technologies as well as electronic recording of liens. If the building contractor fails to pay for the purchase, the lender may proceed to foreclosure steps against the building contractor. This automated credit arrangement created in cooperation between the lender, building supply wholesaler and a building contractor to set up an open line of credit. The system disclosed by the '790 patent application is not a contractor certification system; it does not probe into the operation and business practices of the contractor to determine surety and lender risks.

U.S. patent application Ser. No. 2002/0147708 to Thomas et al discloses a system for providing business information. A data structure is used to communicate contractor business information to outsourcing companies. Contractors provide information regarding their products and services into the system. Outsourcing companies search a database containing contractor information to determine which contractor meets particular search criteria. Selected contractors receive project information and, optionally, a bid template. Bid information is supplied to the database operator. The operator prepares a table of bid information that is sent to the outsourcing companies for review. Evaluation information relating to contractors and outsourcing companies is obtained from both outsourcing companies and contractors and stored on a database. The evaluation information is provided to outsourcing companies and contractors as part of the bid and project information. This is a system for providing contractor business information to outsourcing companies, the information provided is a list of contractors that match specified criteria. The system disclosed by the '708 patent application is not a contractor certification system; it does not probe into the operation and business practices of the contractor to determine surety and lender risks.

U.S. patent application Ser. No. 2003/0028393 to Coulston et al discloses a method and computer program for estimating project costs and time factors and facilitating management of remodeling and construction projects. A method and computer program is described for estimating project costs, time factors and facilitating project management. The project concerns remodeling or construction and the management process involves estimating material and labor costs for each phase of the project. The contract generation process incorporates the estimate of cost and time, special terms or conditions, and procurement of materials and services, including subcontractor services, and scheduling of deliveries and labor, including hourly workers. The computer program comprises a number of cross-platform, fully-integrated subprograms and databases, including an Estimator Subprogram; a Materials Database; a Contract Subprogram; a Production Subprogram; a Worker Database; a Subcontractor Database; and a Vendor Database. Each subprogram is operable and imports data either entered or generated from other sub-programs and databases as needed.

This computer program links estimator, contractor and production sub-programs with materials, worker, sub-contractor and worker databases and is operable in several platforms and estimates project costs, project times and time factors to optimize a remodeling and construction project. Clearly, there is no disclosure concerning a contractor certification system. Moreover, the system disclosed by the Coulston et al. patent application does not probe into the operation and business practices of the contractor to determine surety and lender risks.

Japanese Patent No. JP02002097792 to Takada discloses a work evaluation system and its method. Specifically, in practice of the method an input person enters the responses by a contractor to evaluate a contractor against a standard set by the computer system. The input person acts as a moderator in filling entries to questions posed by the computer system. The system disclosed by the '792 patent is not a contractor certification system; and it does not probe into the operation and business practices of the contractor to determine surety and lender risks.

Japanese Patent No. JP02002203067 to Aisaka discloses a housing performance evaluation certification system. This system creates a performance prediction based on the performance data of various materials used in the construction based on data provided by the manufacturer of these various materials. This system creates a performance prediction based on the performance data of various materials used in the construction based on data provided by the manufacturer of these various materials. The system disclosed by the '067 patent is not a contractor certification system; and it does not probe into the operation and business practices of the contractor to determine surety and lender risks.

Japanese Patent No. JP02002251429 to Saito et al. discloses a system for evaluating housing performance during an earthquake. A device senses the vibration pattern of a house and determines its earthquake resistance. The system disclosed by the Saito et al. patent is not a contractor certification system; it does not probe into the operation and business practices of the contractor to determine surety and lender risks.

Japanese Patent No. JP411232496 to Tsuchiya et al. discloses a method for issuing a certificate and its device. A machine automatically issues a certificate when data is entered into the machine. There is no verification of contractor's performance in any manner. The automatic certificate issuing system disclosed by the '496 patent is not a contractor certification system; and it does not probe into the operation and business practices of the contractor to determine surety and lender risks.

Internet Publication Contractors Certification Division at http://www.co .palm-beach.fl.us/PZB/new/contractors/newcontractors.htm discloses a practice followed by Palm Beach County in certifying contractors. The purpose of Contractors' Certification is to promote, protect and improve the health, safety and welfare of the citizens of Palm Beach County through a contractor's certification and regulation system; to assure compliance with state and county construction licensing regulations and to minimize losses to the public due to unlawful conduct of both certified and uncertified contractors. The Certification Division was established to support the operations of the Construction Industry Licensing Board of Palm Beach County (CILB). The CILB was created by Special Act 67-1876 in 1967; it is comprised of fifteen (15) member's representative of the construction industry and citizens within Palm Beach County. The CILB is responsible for approving all applications for certification examination, requests for change of status, and may take disciplinary action against a county certified contractor for violations of contractor certification laws The purpose of the CILB is clearly set forth in the Special Act, which recognizes that the business of construction and home improvements is a matter affecting the public interest, and any person engaging in the business as herein defined shall be required to establish competency and qualifications to be certified. The Contractor's Certification disclosed by the Internet Publication is a board certification of a contractor for health, safety and welfare of citizens and has nothing to do with the risks faced by sureties and lending institutions interacting with a contractor. CILB certification is not a contractor certification system that probes into the operation and business practices of the contractor to determine surety and lender risks.

Internet Publication Service Magic having a website at http://www.servicemagic.com/discloses ServiceMagic literature. ServiceMagic has pre-screened and rated over 30,000 contractors and real estate agents for home improvement, repair and move-related needs. Services include: remodelers, home builders, architects, landscapers, deck and pool contractors, roofers, plumbers, maids and more. A FREE, no obligation service is backed by a Service Guarantee. The ServiceMagic publication lists contractors, and rates them with unknown procedures. No disclosure is contained by the ServiceMagic publication concerning a system that evaluates contractors for a surety or lending institution. In addition, the ServiceMagic publication does not disclose a contractor certification system. Moreover the system disclosed by the ServiceMagic publication does not probe into the operation and business practices of the contractor to determine surety and lender risks.

There remains a strong need in the art for a contractor certification system that evaluates contractor's business and financial practices and issues an unbiased objective report on the contractor's performance and lender risks as compared to industry standards. This issued report may be used to increase the confidence level of surety institutions when underwriting loans. The contractor may use this report as a third party assessment to improve his marketing performance. Customers of the contractors may be provided information about how the contractor's practices compare with the industry standards.

### SUMMARY OF THE INVENTION

The present invention provides a contractor certification system for evaluating a contractor's business and financial practices in an accurate, efficient and highly reliable manner. The system issues an unbiased objective report describing the contractors performance and lender risks, as compared to industry standards. This issued report may be used to increase the confidence level of surety and financial institutions when underwriting bonds and loans. A contractor may use this report as a third party assessment to improve his marketing performance. Customers of the contractors may be provided information about how the contractor's practices compare with industry standards.

Generally stated, the contractor certification system incorporates a survey using a questionnaire that has objective non-threatening questions, and is provided to the principals within a contractor's business. The answers to questions provide underlying information concerning the business and financial practices of the contractor. In particular, questions are directed to organizational aspects of the business including how the authority is delegated and decisions are made. Other sets of questions are directed to marketing methods and bidding practices as well as project execution practices. Special attention is paid to safety and regulation and compliance issues and past litigation and other liabilities. Technical Evaluators analyze the answers, a strategy is mapped for job site visits and candidates are selected for on location interviews. Using all the information gathered on the contractor's business and financial practices, the Technical Evaluators compare the contractor's business and financial practices, including risk factors with that of similar companies in the database of the evaluating company. This database is an accumulation of business and financial practices of previously examined companies with historical data on meeting project time lines and project expense goals. This comparison results in a report, which ranks the contractors business and financial practice in relation to industry standards. The comparison report is sent to surety institutions and to the contractor. A logo contained in the report graphically depicts a “hobo” wearing a top hat that is partially colored. The colored portion extends upward from base of the hat toward the top portion thereof; the uncolored portion varies inversely with the contractor's grade. A contractor may use this logo as an advertising tool in commercial correspondence to graphically indicate his rank to prospective customers.

The contractor certification system provides a third party, unbiased, objective analysis of a contractor's business and financial practices using professionals specifically trained to conduct the evaluation. Upon being generated, the report provides a complete analysis of risks associated with the contractor's business and financial practices. This report allows surety and financial institutions to confidently underwrite credit agreements with the contractor at a reasonable rate; it avoids higher rate underwriting charges, which might otherwise be required to account for potential failures in a contractor's operations. This form of objective unbiased analysis by a third party also helps the contractor to obtain credit at the best rate available. The contractor is thereby provided an opportunity to improve his business and financial practices, and to document them through contractor certification system reports on an annual basis.

### BRIEF DESCRIPTION OF DRAWINGS

The invention will be more fully understood and further advantages will become apparent when reference is had to the following detailed description and the accompanying drawings, in which:

FIG. 1 is a schematic representation of steps carried out during practice of the contractor certification process;

FIG. 2 is a chart listing a set of questions presented within the organizational category, the questions being designed to probe the management and reporting structures of the company, as well as internal communications and responsibilities of the company management;

FIGS. 3a, 3b and 3c depict a set of questions posed in the capacity category, the questions probing a company's operational structure, reporting structure, internal communications and responsibilities of the company management;

FIG. 4a, 4b, 4c and 4d depict a typical comparative report issued by the Technical Evaluator to the contractor, and to a surety or lending institution; and

FIG. 5 is a flowchart depicting the contractor certification process.

### DESCRIPTION OF THE PREFERRED EMBODIMENTS

The present invention provides a system for annual contractor certification, wherein the business practices of the contractor are gathered through surveys containing objective non-threatening questions and directed interviews with carefully selected employees and principals. The business practices include operational details, financial practices, and interaction with suppliers and processes in place for meeting time lines and cost targets. This data is compiled with discrepancies revealed to determine the ranking of the contractor, as compared to industry standards. A report is then issued, together with contractor certification. This document provides adequate data for financial institutions to provide lines of credit for the contractor, and the institutions are better informed of the degree of risk. A smoother interaction is thereby provided between the financial institution and contractors; the contractor receives the highest rating, and credit level, he deserves. Due to the third party, independent evaluation and ranking of the contractor financial institutions are relieved from having to assess a contractor's capabilities and financial risk using less competent evaluators and subjective standards that oftentimes lack industry wide recognition.

Surety and lending institutions provide contractors with needed operational capital and bond credit for purchasing building supplies, operational expenses and performance guarantees A large risk is involved in surety and lending practice since a contractor may not be able to pay back the loan in time, due to various factors. Oftentimes sureties and lending institutions rely on a contractor's previous experiences; and attempt to reduce lending risks by charging higher interest rates, especially when risk levels are perceived to be high. These sureties and lending institutions have neither the time nor the expertise to probe the details of a contractor's operational and financial practices. The decline of a contractor occurs gradually with signs of deterioration visible only in the very late stages, at which point the damage has already occurred. Key factors in improving the relationship between the contractor and a surety or lending institution are independent objective assessments of the contractor's operational and financial practices. These factors are difficult to determine since they are well hidden within the contractor's operations and have to be probed carefully during a friendly, yet objective examination.

The Contractor Certification System is designed to probe into various aspects of a contractor's business to determine extant business and financial practices. In this manner there is obtained an objective evaluation of a contractor's risk value for surety and lending institutions. The certification system employs various stages of inquiry to assess the contractor's capabilities.

The first step of the process involves sending out a questionnaire to the principal or selected candidates from the contractor's business. These candidates may be drawn from different organizational levels; and can comprise workers, foremen, project managers, engineers and principals. The questionnaire has issues framed in a non-threatening language to obtain critical information of the operations and financial aspects of the contractor's business. Issue-Questions pertains to various categories, including 1) Organization, and 2) Capacity. The Organization questions have several sub categories, including organizational structure, management reporting (internal), authority/approval practices, internal communications/providing information/data exchange practices and management responsibilities. The capacity questions have several sub categories, including project information, operational personnel and construction services. Once completed, the questionnaire is sent to Construction Risk Technology, the company managing the contractor certification system and is evaluated by Technical Evaluators. At the second step, the Technical Evaluators study each answer to the questions, and derive there from a framework of directions that probe within the operations and financial practices of the contractor.

The third step requires the Technical Evaluators to visit project sites and interview several candidates associated with the contractor's organization. During this step, the Technical Evaluators of Construction Risk Technology ask directed questions and observe examples of the contractor's business practices as well as financial procedures the contractor has in place. The Technical Evaluators visit several active job sites, at which the contractor is actively involved. An open atmosphere promoting friendly communication determines the validity of answers provided and unearths discrepancies in extant operational and financial procedures. Small contractors need only interview with one Technical Evaluator, while larger contractors may require several Technical Evaluators. The Technical Evaluators then create a report detailing their observations and providing them to the management of the company managing the contractor certification system, hereinafter “Construction Risk Technology”.

During the fourth step of the process, the Technical Evaluators assess the gathered information and determine if they have sufficient information. Additional job site visits and interviews may be conducted at the fifth step. At the sixth step, the contractor's rank is determined by Construction Risk Technology, which has compiled a list of risk and performance factors of contractors from the contractor's and the Technical Evaluator's provided information. These factors are dependent on the size of the contractor's operation and the type of contracts with which a particular contractor is involved. A comparison is made against Industry Standards to assign a ranking for each contractor visited by a Technical Evaluator. This comparison is carried out for each of the aspects probed; an overall score is determined for the contractor. Construction Risk Technology then issues a report at step seven, which includes a comparative grade for the contractor. Copies of the report are sent to the contractor and the surety, lending institution or others as directed by the contractor. The comparative grade provided by the report can be exhibited by the contractor in prospective commercial correspondence. A logo graphically depicting a hobo wearing a top hat having an extended height typically accompanies the correspondence. The hat is partially colored; so that the colored portion extends upward from its base toward the top portion thereof. The portion of the hat left uncolored varies inversely with the contractor's grade.

The Contractor Certification System also provides for an annual follow-up assessment. During this phase, a new questionnaire is completed and returned to Construction Risk Technology, the company managing the contractor certification system. The Technical Evaluator schedules a visit with the contractor and visits selected projects with which the contractor is engaged. At the conclusion of the assessment a report is sent to the contractor and surety. Marginal contractors are provided a chance to remedy their problems and prove to sureties that they are worthy of continued or additional surety credit.

The Contractor Certification System provides objective assessment to support underwriters' determinations. A validation of contractors' claimed capabilities is also obtained. The Contractor Certification System also provides certification for subcontractors. Surety brokers can be provided an independent evaluation of their clients. The Contractor Certification System assists the broker in preparing their surety submission.

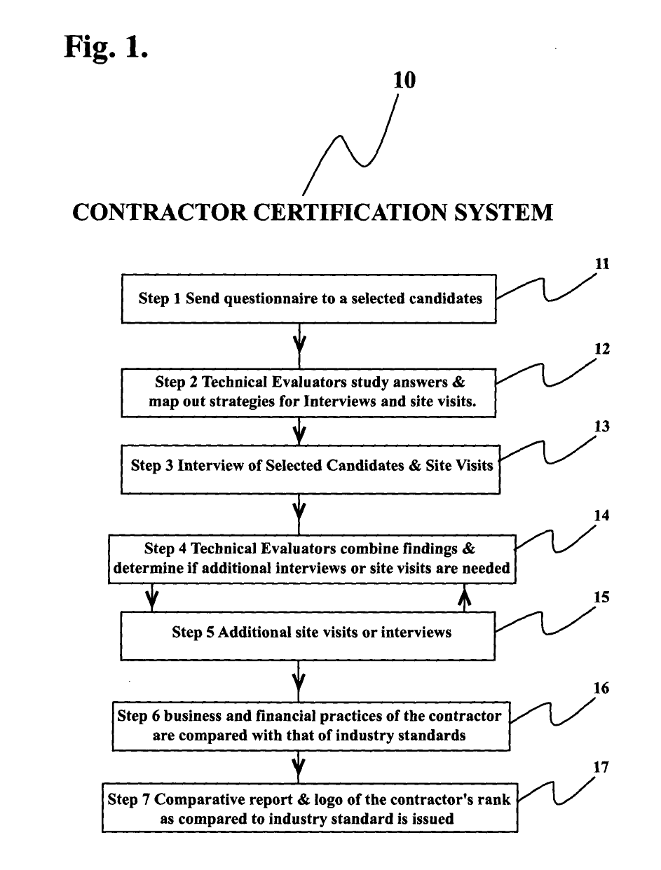

In FIG. 1 there is shown generally at step 10 a schematic representation of the steps in the contractor certification process. As shown, a series of steps must be taken to evaluate a contractor's business practice. Referring to step 11, a questionnaire relating to contractor's business is sent to a number of selected candidates within the contractor's business. These candidates may include workers, foremen, project managers, engineers and principals. Non-threatening questions contained by the questionnaire may be answered by each of the selected candidates. Depending on their roles in the organization, these candidates may submit substantially different answers and reference divergent illustrative incidents. Completed questionnaires are sent to Construction Risk Technology, the evaluating company. Referring to step 12, the Technical Evaluators of Construction Risk Technology examine the details of the answers and correlate them to determine clear matches, clear discrepancies and inadequate details. Based on this analysis, the Technical Evaluators map out strategies for interviews and visits to several job site inspections. At step 13, the Technical Evaluators visit the contractor and set up interviews with targeted employees or principals probing specific areas. The Technical Evaluators also visit contractor's work locations to determine work practices and financial procedures. In a small contracting company, one Technical Evaluator may accomplish most of these tasks. Larger contracting operations will require the coordinated effort of several Technical Evaluators. Referring to step 14, the Technical Evaluators combine their findings and determine if additional interviews or job site visits are needed. At step 15 additional job site visits or interviews are conducted to assess the business and financial practices of the contractor. Steps 14 and 15 are reiterated until the Technical Evaluators are satisfied that they have acquired adequate information. Referring to step 16, the business and financial practices of the contractor are compared with that of industry standards for contractors of a selected size and type of contractor work. This standard exists within Construction Risk Technology, the evaluating company, as a database derived from evaluated contractor business and financial practices and the records of surety risk associated with their practices. At step 17, a comparative report of the contractor's rank as compared to industry standards, is issued. The comparative grade provided by the report can be exhibited by the contractor in prospective commercial correspondence. A logo graphically depicting a hobo wearing a top hat having an extended height typically accompanies the correspondence. The hat is partially colored; so that the colored portion extends upward from its base toward the top portion thereof. The portion of the hat left uncolored varies inversely with the contractor's grade.

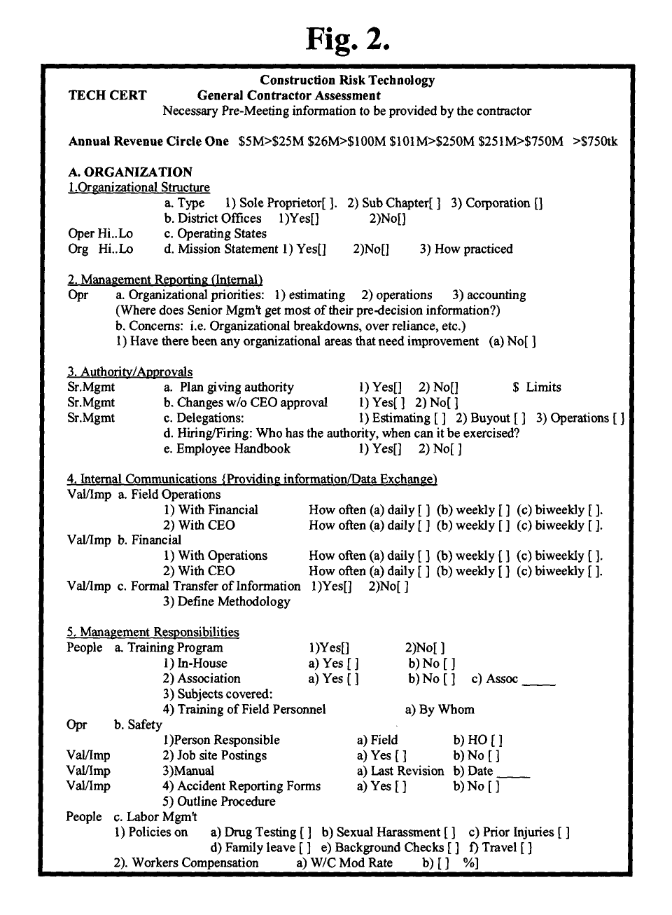

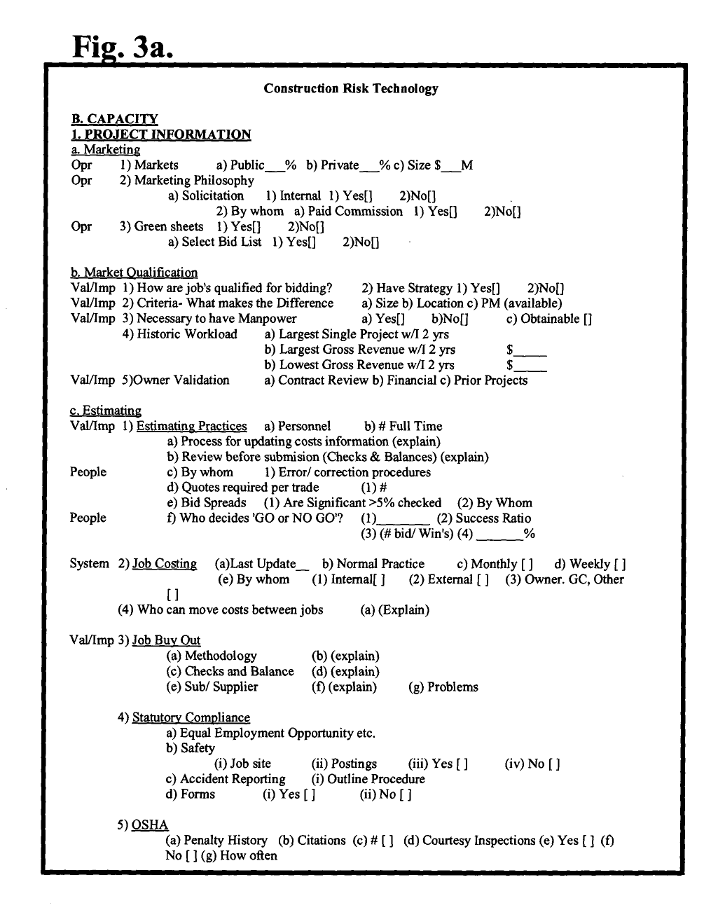

In FIG. 2 there is listed a set of questions presented within the organizational category. These questions are designed to probe the management structure of the company, as well as the reporting structure therein, company internal communications and responsibilities of the company management. Key issues comprise: (i) the mechanism by which a decision is made; (ii) how the decision relates to reporting structure; (iii) the mechanism for delegating authority within the company; and (iv) how the financial and operational details are communicated across the management chain. Particular emphasis is based on safety issues and labor management practices, which may have severe financial implications. These questions probe a company's operational structure, reporting structure, internal communications and responsibilities of the company management.

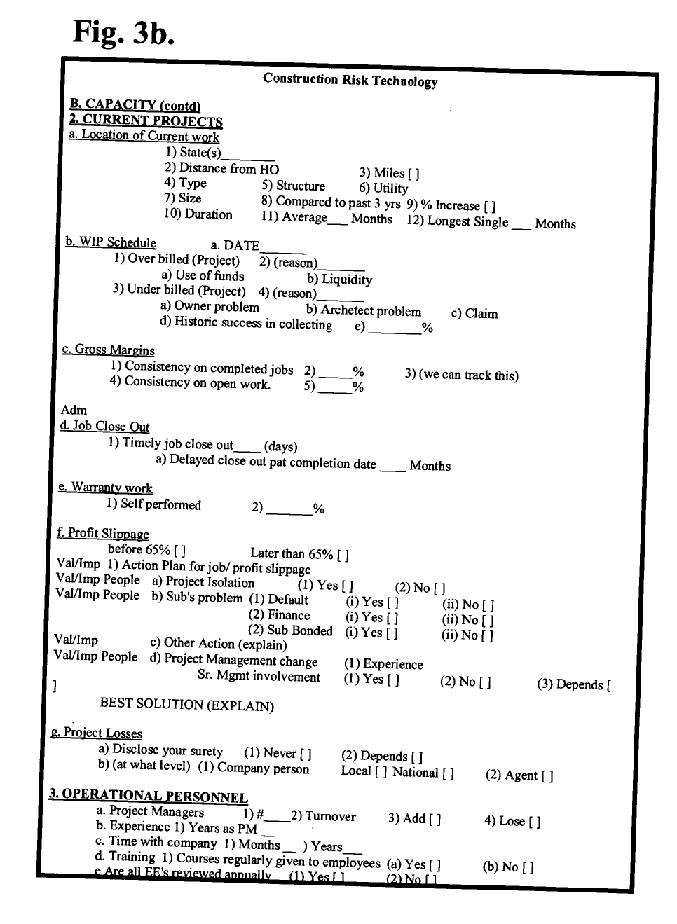

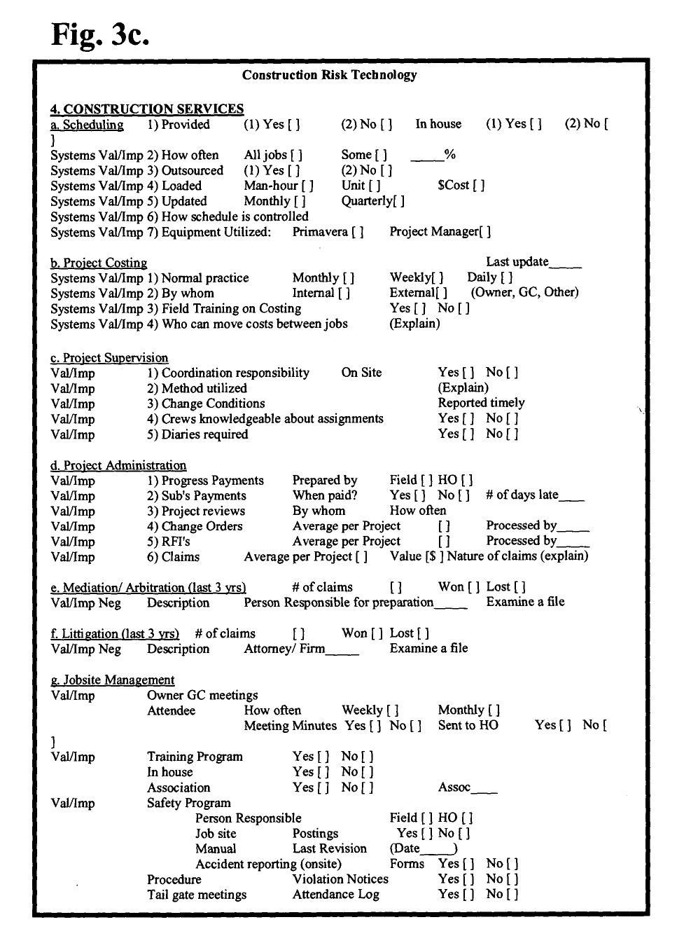

FIGS. 3a, 3b and 3c contain a set of questions posed in the capacity category. FIG. 3a addresses the project information based on marketing methods, how market qualification is determined and how cost estimates are made. Particular emphasis is placed on statutory compliance and OSHA requirements since these two elements may have large risk factors associated with them. FIG. 3b evaluates current projects already underway. Questions relate to location of work, size of work, how the work is funded, and gross margins and close out procedures in place. If warranty work is needed, how is it paid for. Slips in profit margins and project losses, if incurred, are recorded here. The qualifications of personnel assigned to current projects are also recorded. FIG. 3c questions record the details of the construction services, including scheduling practices, project costing methods, project supervision practice and overall project administration in place. Also recorded by the questionnaire are the mediation/arbitration procedures and past litigation record. These questions probe a company's operational structure germane to marketing of new projects, details of execution of current projects, and risk factors associated with safety, statutory compliance and OSHA regulations. Also recorded are procedures in place for mediation and arbitration, as well as details of past litigation. These questionnaires provide a detailed assessment of a contractors business factors, together with embedded risk factors.

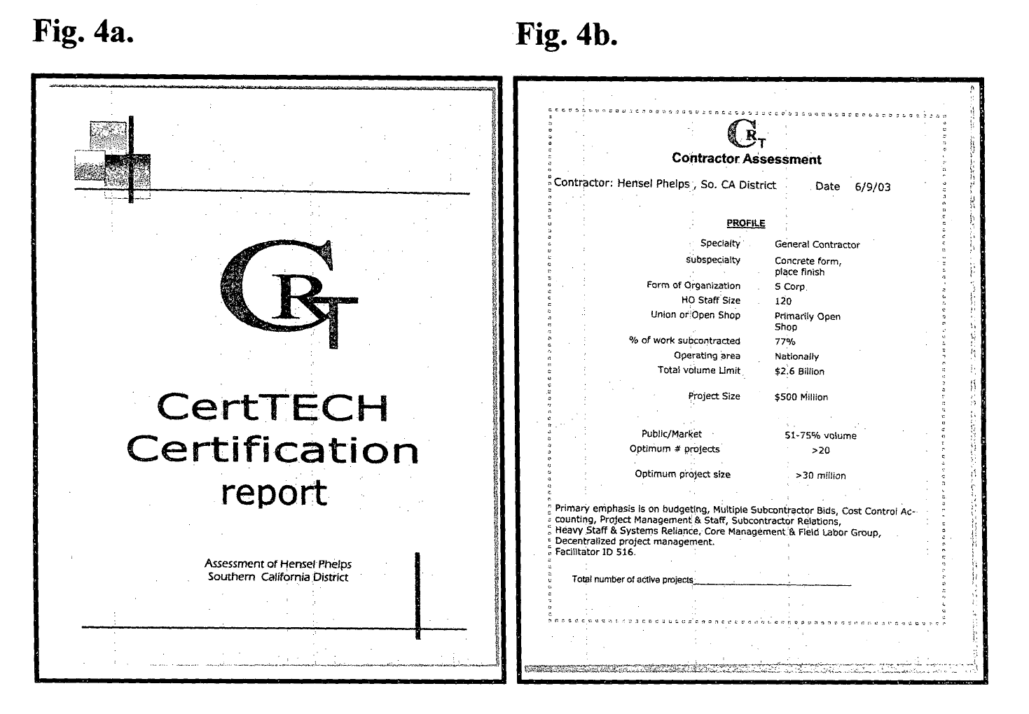

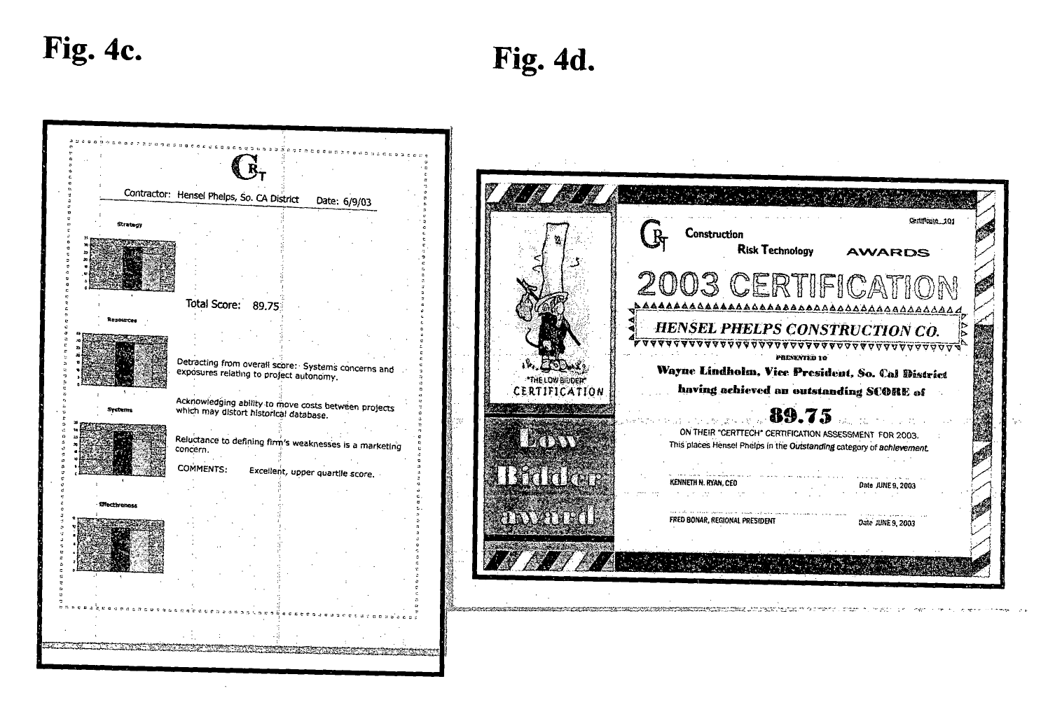

FIG. 4a, b, c and d contains a typical comparative report issued by Construction Risk Technology to the contractor, and to surety or lending institutions. The comparative report provides a listing of key factors that are essential for surety and lender's organizations to underwrite bonds and loans for the contractor. Contractor's business practices and risk factors are highlighted by the report, so that the surety and lending institution can make a valid judgment during the underwriting process. The report enables contractors to be provided with the best possible rate. In addition, the report provides a comfort zone for the surety/ending institutions engaged in underwriting credit for the contractor, thereby resulting in a smoother relationship. Annual re-qualification of a contractor automatically provides evaluation of existing projects in relation to performance schedules and project cost management, so that the surety institutions are automatically updated. The contractor also can increase the annual ranking by improving their business practices.

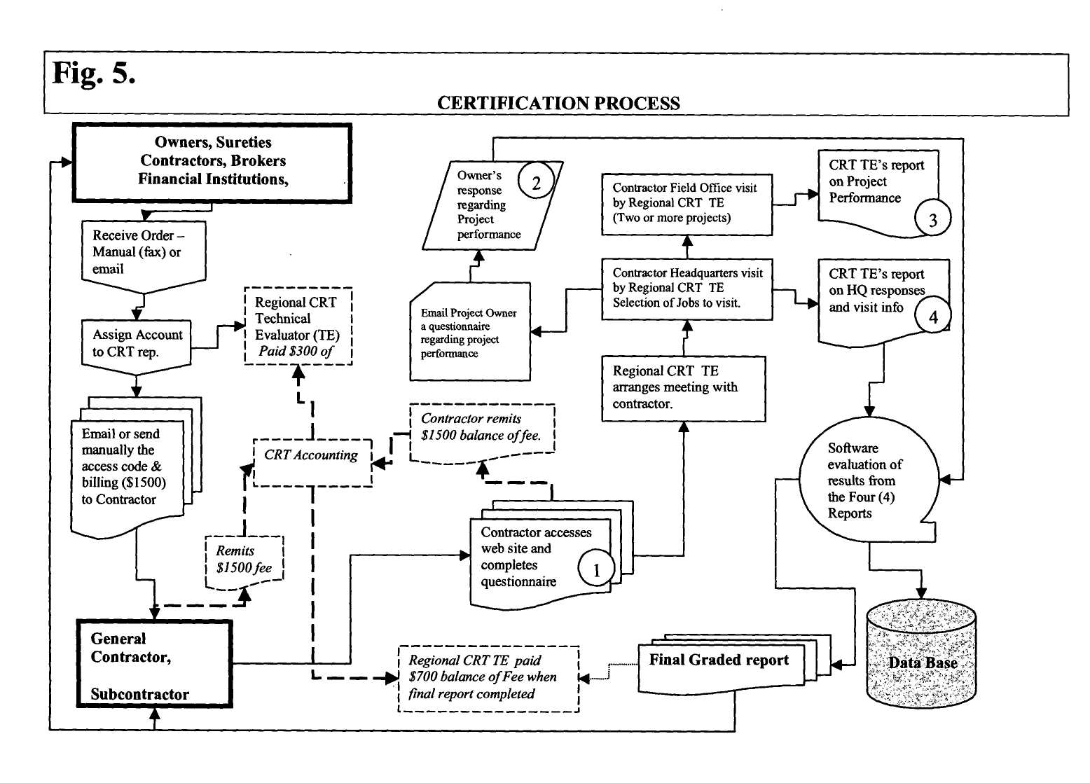

In FIG. 5 there is shown a flow sheet depicting steps involved in the contractor certification process. At step 1 a contractor accesses the Construction Risk Technology web site and completes a questionnaire. Owners, sureties, contractors, brokers or financial institutions may access the web site. The web site system manages setting up an account for the owners, sureties, contractors, brokers or financial institutions and charges a fee accordingly. If a request is made by a contractor, a regional Construction Risk Technology Technical Evaluator arranges a meeting with the contractor to complete interview questionnaires and job site visits. At step 2, the owner's response regarding project performance is obtained. At step 3, the responses from questionnaires as well as details obtained during interviews and job site visits are gathered, compared and analyzed to create a report on project performance by Construction Risk Technology. At step 4, the Construction Risk Technology's report on contractor headquarters' responses together with additional visit information are compiled and gathered. The data obtained in step 4 is stored in the database and is compared with previous contractor evaluations using Construction Risk Technology software and a report is issued, grading the contractor's performance and assigning an appropriate logo. The report is provided to the contractor and is available to authorized personnel at the Construction Risk Technology web site.

Having thus described the invention in rather full detail, it will be understood that such detail need not be strictly adhered to, but that additional changes and modifications may suggest themselves to one skilled in the art, all falling within the scope of the invention as defined by the subjoined claims.

1. A contractor certification system comprising:
a. survey means comprising a questionnaire, which is provided to selected candidates within a contractor's business for assessing business and financial practices;
b. mapping means for studying answers provided to said questionnaire to select job site visits and candidates for interviews;
c. on-location assessment means for determining business and financial practices at the contractor's operations;
d. comparison means for assessing business and financial practices, and ranking the contractor in comparison with industry standards; and
e. reporting means for providing a grade indicative of said contractor's rank.

2. A contractor certification system as recited by claim 1, wherein said questionnaire is composed of non-threatening questions.

3. A contractor certification system as recited by claim 1, wherein said mapping means develops, within said answers to said questions, areas comprising clear matches, clear discrepancies and inadequate details for on location assessment.

4. A contractor certification system as recited by claim 1, wherein said on-location assessments comprise one on one interviews drawn from selected candidates and job site visits.

5. A contractor certification system as recited by claim 1, wherein said comparison means comprises an evaluation of said contractor's business and financial practice data against one or more databases containing performance and risk factor data from similar contractors, stored by the contractor certification system.

6. A contractor certification system as recited by claim 1, wherein said reporting means comprises:
a. a comparison report addressed to said surety institution and said contractor,
b. a logo graphically depicting a hobo wearing a top hat having a base, a top portion, a partially colored portion and an uncolored portion, the colored portion extending upward from said base toward said top portion, and said uncolored portion varying inversely with said grade.

7. A contractor certification system as recited by claim 2, wherein said questionnaire comprises questions directed to organizational aspects with particular reference to management structure, authority delegation and decision-making practices.

8. A contractor certification system as recited by claim 2, wherein said questionnaire comprises questions directed to management practices, with particular reference to marketing, bidding processes, and project execution practices.

9. A contractor certification system as recited by claim 5, wherein said database stored comprises a compilation of business and financial and risk data derived from contractors previously evaluated.

10. A contractor certification system as recited by claim 6, wherein said comparison report sets forth said contractor's business and financial practices with detail sufficient to assist surety institutions engaged in underwriting a contractor's credit line.

11. A contractor certification system as recited by claim 6, wherein said logo is adapted for display in a contractor's letterhead to advertise and communicate said contractor's rank, business and financial practices.
